(19) United States
(12) Patent Application Publication
(10) Pub. No.: US 2026/0200108 A1
(43) Pub. Date: Jul. 16, 2026

(54) TWO-EYE DEVICE FOR ROBOT

(71) Applicant: SAMSUNG ELECTRONICS CO., LTD., Suwon-si (KR)

(72) Inventors: Daesoo KIM, Suwon-si (KR); Byeongcheol LEE, Suwon-si (KR); Hyungmin SON, Suwon-si (KR)

(73) Assignee: SAMSUNG ELECTRONICS CO., LTD., Suwon-si (KR)

(21) Appl. No.: 19/542,270

(22) Filed: Feb. 17, 2026

Related U.S. Application Data
(63) Continuation of application No. PCT/KR2026/000562, filed on Jan. 9, 2026.

(30) Foreign Application Priority Data
Jan. 16, 2025 (KR) 10-2025-0006899

(51) Int. Cl. B25J 19/02; F16M 11/12; G03B 17/56

(52) U.S. Cl. CPC B25J 19/023; F16M 11/126; G03B 17/561

(57) ABSTRACT

A two-eye device for a robot including: a base, a left camera on an upper side of the base, a right camera on the upper side of the base, the right camera is to the right of the left camera. The two-eye device including a motion generating device including a main shaft, the motion generating device is configured to cause the main shaft to perform a linear movement, a rotation, and a helical movement. The two-eye device a left-and-right tilting mechanism connected to the motion generating device. The two-eye device an up-and-down tilting mechanism connected to the motion generating device. The two-eye device a focus adjusting mechanism connected to the motion generating device. The two-eye device a first motor and a second motor configured to operate the motion generating device.

### CROSS-REFERENCE TO RELATED APPLICATIONS

This application is a Bypass Continuation Application of International Application PCT/KR2026/000562 filed on Jan. 9, 2026, which claims benefit of Korean Provisional Application No. 10-2025-0006899, filed on Jan. 16, 2025 filed at the Korean Intellectual Property Office, the disclosure of which are incorporated herein in their entireties by reference.

### BACKGROUND

### FIELD

The disclosure relates to a robot, and more particularly, to a two-eye device for a robot.

### DESCRIPTION OF RELATED ART

With the advancement of robotics technology, various types of robots are being developed for use in a wide range of environments, including industrial, service, and personal applications. In order to perform tasks in such environments, robots often need to perceive surrounding objects, spatial relationships, and changes in their surroundings.

To support such perception, robots may be equipped with vision systems that include multiple imaging devices. For example, a robot may include two eyes to acquire visual information for recognizing objects, distances, and relative positions within a surrounding space. The two eyes may be movably mounted so as to expand a recognizable or observable space.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

According to one or more embodiments of the disclosure, a two-eye device for a robot including a base, a left camera on an upper side of the base, and a right camera on the upper side of the base, the right camera is to the right of the left camera. The two-eye device including a motion generating device including a main shaft, the motion generating device is configured to cause the main shaft to perform a linear movement, a rotation, and a helical movement. The two-eye device including a left-and-right tilting mechanism connected to the motion generating device and configured to simultaneously tilt the left camera and the right camera by an angle in a left or a right direction based on the main shaft performing the linear movement in a direction parallel to the base. The two-eye device including an up-and-down tilting mechanism connected to the motion generating device and configured to simultaneously tilt the left camera and the right camera upward or downward by an angle relative to the base based on the main shaft performing the helical movement. The two-eye device including a focus adjusting mechanism connected to the motion generating device and configured to adjust a focal angle between the left camera and the right camera based on the main shaft performing the rotation. The two-eye device including a first motor and a second motor configured to operate the motion generating device.

In an embodiment the motion generating device includes: a linear bush on a first end portion of the main shaft and configured to rotate the main shaft; a screw bush connected to a second end portion of the main shaft and configured to helically move the main shaft; a first bush gear on an outer circumferential surface of the linear bush and configured to rotate by the first motor; and a second bush gear on an outer circumferential surface of the screw bush and configured to rotate by the second motor.

In an embodiment the main shaft includes: a helical groove on an outer circumferential surface of the main shaft; and a plurality of guide grooves at regular intervals in a circumferential direction on the outer circumferential surface of the main shaft and in a straight line corresponding to a length of the main shaft.

In an embodiment, the linear bush includes: a hollow portion, The main shaft is in the hollow portion; and a plurality of guide protrusions on an inner circumferential surface of the hollow portion and configured to engage with the plurality of guide grooves of the main shaft.

In an embodiment the screw bush includes: a hollow portion, the main shaft is in the hollow portion; and a helical protrusion on an inner circumferential surface of the hollow portion and configured to engage with the helical groove of the main shaft.

In an embodiment, the left-and-right tilting mechanism includes: a sub-shaft configured to move parallel to the main shaft, and to which the left camera and the right camera are connected; and a horizontal link configured to rotate about a link axis perpendicular to the base and including a first end to receive the linear movement of the main shaft and a second end connected to a central portion of the sub-shaft. Based on the main shaft of the motion generating device performing the linear movement, the sub-shaft is configured to move linearly by the horizontal link, so that the left camera and the right camera are simultaneously tilted to the left or right by an angle.

In an embodiment, the left-and-right tilting mechanism further includes: a lead screw at a central portion of the main shaft; a screw nut coupled to the lead screw and connected to a first end of the horizontal link; and a linear movement guide member below the screw nut and configured to guide a linear movement of the screw nut.

In an embodiment, the focus adjusting mechanism includes: a first focus gear on the main shaft; a sub-shaft parallel to the main shaft and including a central portion, a left-hand thread portion on one side of the central portion, and a right-hand thread portion on another side of the central portion; a second focus gear at one end of the sub-shaft and configured to mesh with the first focus gear; a left nut on the left-hand thread portion of the sub-shaft and connected to the left camera; and a right nut on the right-hand thread portion of the sub-shaft and connected to the right camera.

In an embodiment, the left camera is configured to pivot left and right at an angle about a first vertical axis perpendicular to the base, and the right camera is configured to pivot left and right at an angle about a second vertical axis perpendicular to the base.

In an embodiment, the up-and-down tilting mechanism includes: a first tilting gear on the main shaft; a second tilting gear meshed with the first tilting gear; a tilting shaft parallel to the main shaft and at a center of the second tilting gear; a right two-bar link adjacent to the second tilting gear and having a first end connected to the tilting shaft and a second end connected to the right camera; and a left two-bar link spaced apart from the right two-bar link by an angle and having a first end connected to the tilting shaft and a second end connected to the left camera.

In an embodiment, the left camera is configured to pivot upward and downward at an angle about a horizontal axis parallel to the tilting shaft, and the right camera is configured to pivot upward and downward at an angle about the horizontal axis.

In an embodiment, the main shaft includes a spline, the first tilting gear includes a spline boss, the spline is in the spline boss, and the first tilting gear is rotatably supported by a rotation support on the base.

In an embodiment, the left camera includes a left tilting bracket configured to support the left camera so that the left camera is able to tilt left and right and upward and downward, and the right camera includes a right tilting bracket configured to support the right camera so that the right camera is able to tilt left and right and upward and downward.

In an embodiment, the left tilting bracket includes: a horizontal hinge behind the left camera and configured to support the left camera to tilt upward and downward; a vertical hinge perpendicular to and integrally with the horizontal hinge and configured to support the horizontal hinge to tilt left and right; and a connecting portion to protrude from the horizontal hinge toward the motion generating device, and the right tilting bracket includes: a horizontal hinge behind the right camera and configured to support the right camera to tilt upward and downward; a vertical hinge perpendicular to and integrally with the horizontal hinge and configured to support the horizontal hinge to tilt left and right; and a connecting portion to protrude from the horizontal hinge toward the motion generating device.

In an embodiment, based on the left-and-right tilting mechanism operating, the left camera is configured to tilt left and right about the vertical hinge of the left tilting bracket, and the right camera is configured to tilt left and right about the vertical hinge of the right tilting bracket, and based on the up-and-down tilting mechanism operating, the left camera is configured to tilt upward and downward about the horizontal hinge of the left tilting bracket, and the right camera is configured to tilt upward and downward about the horizontal hinge of the right tilting bracket..

### BRIEF DESCRIPTION OF THE DRAWINGS

These and/or other aspects, features, and advantages of certain embodiments of the disclosure will be more apparent from the following description taken in conjunction with the accompanying drawings, in which:

FIG. 1 is a perspective view illustrating a portion of a robot having a two-eye device according to one or more embodiments of the disclosure.

FIG. 2 is a front view illustrating a portion of a robot having a two-eye device according to one or more embodiments of the disclosure.

FIG. 3 is a perspective view illustrating a two-eye device for a robot according to one or more embodiments of the disclosure.

FIG. 4 is a side view illustrating a linear bush coupled to a main shaft of a two-eye device for a robot according to one or more embodiments of the disclosure.

FIG. 5 is a perspective view illustrating a main shaft and a linear bush of a two-eye device for a robot according to one or more embodiments of the disclosure.

FIG. 6 is a cross-sectional view illustrating a screw bush coupled to a main shaft of a two-eye device for a robot according to one or more embodiments of the disclosure.

FIG. 7 is a perspective view illustrating a main shaft and a screw bush of a two-eye device for a robot according to one or more embodiments of the disclosure.

FIG. 8 is a perspective view illustrating a two-eye device for a robot viewed in the Y-direction according to one or more embodiments of the disclosure.

FIG. 9 is a plan view of the two-eye device for a robot of FIG. 8 according to one or more embodiments of the disclosure.

FIG. 10 is a perspective view illustrating a state in which a horizontal link is separated from a main shaft of a two-eye device for a robot according to one or more embodiments of the disclosure.

FIG. 11 is a view illustrating a state in which left and right cameras of a two-eye device for a robot are tilted to the right according to one or more embodiments of the disclosure.

FIG. 12 is a cross-sectional view illustrating the two-eye device for a robot taken along line A-A of FIG. 9 according to one or more embodiments of the disclosure.

FIG. 13 is a perspective view illustrating a first tilting gear of a two-eye device for a robot according to one or more embodiments of the disclosure.

FIG. 14 is a cross-sectional view illustrating a state in which a right camera of the two-eye device for a robot of FIG. 12 is tilted downward according to one or more embodiments of the disclosure.

FIG. 15 is a perspective view illustrating a two-eye device for a robot viewed in the Y direction according to one or more embodiments of the disclosure.

FIG. 16 is a plan view illustrating the two-eye device for a robot of FIG. 15 according to one or more embodiments of the disclosure.

FIG. 17 is a partial plan view illustrating left and right cameras of a two-eye device for a robot in a focused state according to one or more embodiments of the disclosure.

FIG. 18 is a functional block diagram illustrating a two-eye device for a robot according to one or more embodiments of the disclosure.

FIG. 19 is a flowchart illustrating operation of a two-eye device for a robot according to one or more embodiments of the disclosure.

### DETAILED DESCRIPTION

Various embodiments of this document and terms used herein are not intended to limit the technical features described in this document to specific embodiments, but should be understood to include various modifications, equivalents, or alternatives of the embodiments.

In connection with the description of the drawings, similar reference numbers may be used for similar or related components.

The singular form of a noun corresponding to an item may include one or more of the above item, unless the relevant context clearly indicates otherwise.

In this document, each of phrases such as “A or B,” “at least one of A and B,” “at least one of A or B,” “A, B, or C,” “at least one of A, B, and C,” “at least one of A, B, C” may include any one of the items listed together with the corresponding phrase, or any possible combination thereof.

The term “and/or” includes any element of a plurality of related described elements or a combination of a plurality of related described elements.

Terms such as “first,” “second,” “primary,” or “secondary” may be used simply to distinguish one component from other components, and do not limit the corresponding components in other respects (e.g., importance or order).

When it is mentioned that one (e.g., first) component is “coupled” or “connected” to another (e.g., second) component with or without terms “functionally” or “communicatively”, it means that the one component can be connected to the another component directly (e.g., wired), wirelessly, or through a third component.

Terms such as “include” or “have” are intended to designate the presence of features, numbers, steps, operations, components, parts, or combinations thereof described in the embodiment, but do not preclude the presence or addition of one or more other features, numbers, steps, operations, components, parts, or combination thereof.

When a component is said to be “connected,” “coupled,” “supported,” or “in contact” with another component, this means not only cases where the components are directly connected, coupled, supported, or contacted, but also cases where the components are indirectly connected, coupled, supported, or contacted through a third component.

When a component is said to be located “on” other component, this includes not only cases where the component is in contact with the other component, but also cases where another component exits between the two components.

Further, the terms ‘leading end’, ‘rear end’, ‘upper side’, ‘lower side’, ‘top end’, ‘bottom end’, etc. used in the disclosure are defined with reference to the drawings. However, the shape and position of each component are not limited by the terms.

The disclosure provides a two-eye device for a robot capable of performing up-and-down tilting, left-and-right tilting, and adjusting focal angle adjustment of a left camera and the right camera using two motors. In some embodiments, the two-eye device may only include two motors.

Hereinafter, a two-eye device for a robot 1 according to one or more embodiments of the disclosure will be described in detail with reference to the accompanying drawings.

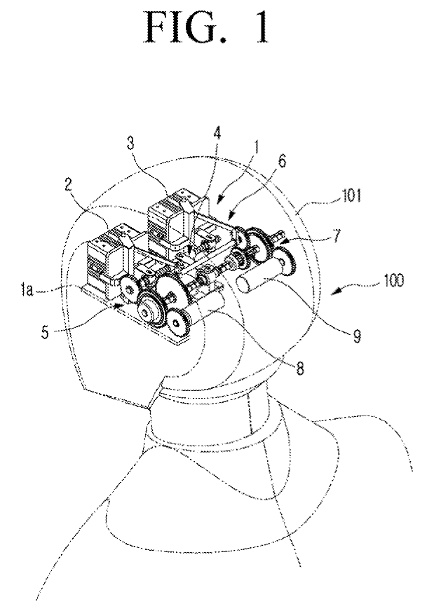

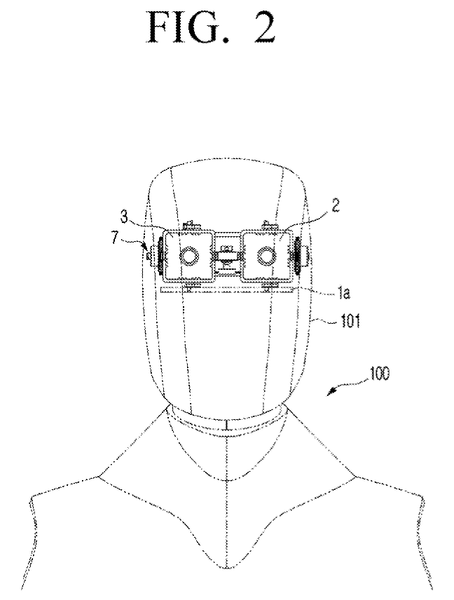

FIG. 1 is a perspective view illustrating a portion of a robot 100 having a two-eye device 1 according to one or more embodiments of the disclosure. FIG. 2 is a front view illustrating a portion of a robot 100 having a two-eye device 1 according to one or more embodiments of the disclosure.

Referring to FIGS. 1 and 2, a two-eye device 1 for a robot according to one or more embodiments of the disclosure may be disposed in a robot 100. For example, the two-eye device 1 for a robot according to one or more embodiments of the disclosure may be disposed in a head 101 of a humanoid robot 100.

The two-eye device 1 for a robot according to one or more embodiments of the disclosure may include two cameras that function as eyes, a left camera 2 and a right camera 3. The left camera 2 and the right camera 3 may be spaced apart from each other by a certain distance in the horizontal direction.

The two-eye device 1 for a robot according to one or more embodiments of the disclosure may be configured to enable up-and-down tilting, left-and-right tilting, and focal angle adjustment of the left camera 2 and the right camera 3.

The two-eye device 1 for a robot according to one or more embodiments of the disclosure may include an up-and-down tilting mechanism 5 configured to tilt the left camera 2 and the right camera 3 up and down, a left-and-right tilting mechanism 4 configured to tilt the left camera 2 and the right camera 3 left and right, a focus adjusting mechanism 6 configured to adjust a focal angle between the left camera 2 and the right camera 3, and a motion generating device 7 configured to selectively operate the up-and-down tilting mechanism 5, the left-and-right tilting mechanism 4, and the focus adjusting mechanism 6.

The motion generating device 7 may be configured to selectively operate the up-and-down tilting mechanism 5, the left-and-right tilting mechanism 4, and the focus adjusting mechanism 6.

The motion generating device 7 may include a main shaft 10 and may be configured to move the main shaft 10. For example, the motion generating device 7 may be configured to cause the main shaft 10 to perform one of linear movement, rotation, and helical movement. In other words, the main shaft 10 may selectively perform one of a linear movement, a rotation, and a helical movement by the motion generating device 7. In some embodiments, the motion generating device 7 may be configured to cause the main shaft 10 to perform a linear movement, a rotation, and a helical movement. The linear movement may refer to a motion in which the main shaft 10 moves in a straight line without rotating, the rotation may refer to a motion in which the main shaft 10 rotates without moving in a straight line, and the helical movement may refer to a motion in which the main shaft 10 rotates while simultaneously moving in a straight line.

For example, the motion generating device 7 may include the main shaft 10, a linear bush 20 disposed at one end portion of the main shaft 10, and a screw bush 30 disposed at the other end portion of the main shaft 10.

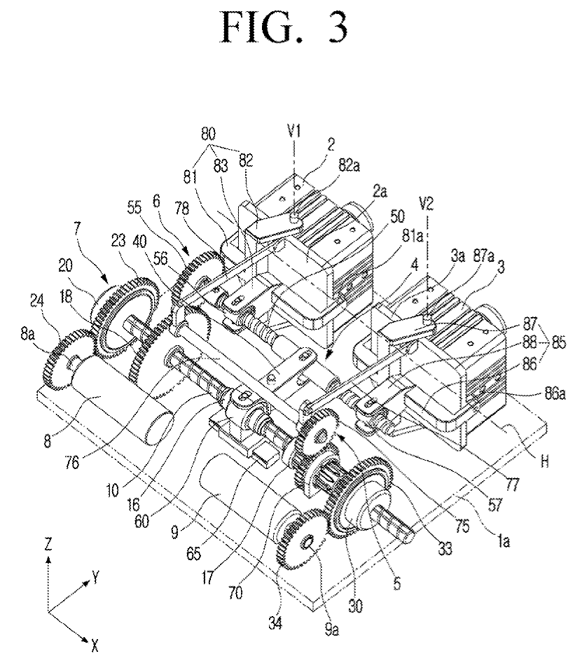

The motion generating device 7 may include a first motor 8 and a second motor 9 to operate the main shaft 10. For example, as shown in FIG. 3, the motion generating device 7 may include the first motor 8 configured to rotate the linear bush 20 and the second motor 9 configured to rotate the screw bush 30.

The left-and-right tilting mechanism 4 may be connected to the motion generating device 7. The left-and-right tilting mechanism 4 may be configured so that when the main shaft 10 of the motion generating device 7 moves linearly in a direction parallel to the base 1a, the left-and-right tilting mechanism 4 simultaneously tilts the left camera 2 and the right camera 3 in the left-right direction, i.e., in the left or right direction, by a certain angle.

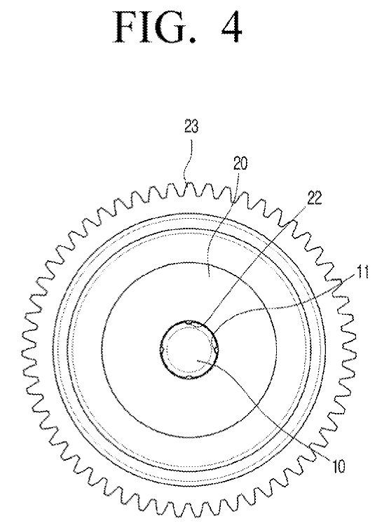

For example, as shown in FIG. 4, the left-and-right tilting mechanism 4 may include a horizontal link 40 connected to the main shaft 10 and a sub-shaft 50 connected to the horizontal link 40. The main shaft 10 and the sub-shaft 50 may be connected by the horizontal link 40. Therefore, when the main shaft 10 moves linearly, the sub-shaft 50 may move linearly by the horizontal link 40.

The left camera 2 and the right camera 3 may be connected to both sides of the sub-shaft 50 so as to be able to pivot left and right. Therefore, when the sub-shaft 50 moves linearly left and right, the left camera 2 and the right camera 3 may tilt left and right.

The up-and-down tilting mechanism 5 may be connected to the motion generating device 7. The up-and-down tilting mechanism 5 may be configured so that when the main shaft 10 of the motion generating device 7 performs the helical movement, the up-and-down tilting mechanism 5 simultaneously tilts the left camera 2 and the right camera 3 in the up-and-down direction, i.e., in the upward direction or downward direction, relative to the base 1a by a certain angle.

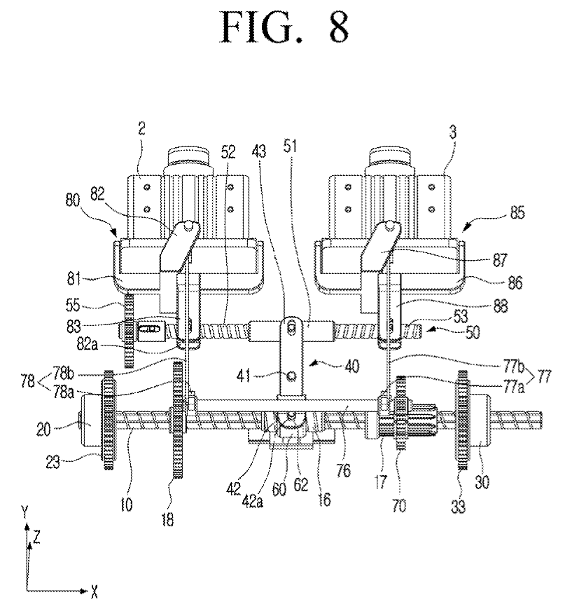

For example, as shown in FIG. 8, the up-and-down tilting mechanism 5 may include a tilting gear train 70 and 75 and a pair of two-bar links 77 and 78. The tilting gear train 70 and 75 may be configured to convert the helical movement of the main shaft 10 into a rotational motion and transmit the rotational motion to the pair of two-bar links 77 and 78. The pair of two-bar links 77 and 78 may be connected by a tilting shaft 76. Therefore, when the main shaft 10 of the motion generating device 7 performs the helical movement, the pair of two-bar links 77 and 78 may move forward and backward, i.e., in the Y-axis direction, by the tilting gear train 70 and 75 and the tilting shaft 76.

The left camera 2 and the right camera 3 may be connected to one ends of the pair of two-bar links 77 and 78. The left camera 2 and the right camera 3 may be disposed to tilt at a certain angle with respect to the horizontal axis H. Therefore, when the pair of two-bar links 77 and 78 move forward and backward, the left camera 2 and the right camera 3 may be tilted up and down.

The focus adjusting mechanism 6 may be connected to the motion generating device 7. The focus adjusting mechanism 6 may be configured so that when the main shaft 10 of the motion generating device 7 rotates, the focus adjusting mechanism 6 adjusts a focal angle between the left camera 2 and the right camera 3.

For example, as shown in FIG. 8, the focus adjusting mechanism 6 may include a focus gear train 18 and 55 and the sub-shaft 50. The focus gear train 18 and 55 may be configured to transmit the rotation of the main shaft 10 to the sub-shaft 50. Therefore, when the main shaft 10 rotates, the sub-shaft 50 may be rotated by the focus gear train 18 and 55.

The left camera 2 and the right camera 3 may be disposed on the left portion 52 and the right portion 53 of the sub-shaft 50, respectively. The left camera 2 and the right camera 3 may be disposed to tilt left and right by a certain angle about a first vertical axis V1 and a second vertical axis V2, respectively. Therefore, when the sub-shaft 50 rotates, the left camera 2 and the right camera 3 may tilt by a certain angle in opposite directions, thereby adjusting the focal angle between the left camera 2 and the right camera 3.

Hereinafter, the two-eye device 1 for the robot according to one or more embodiments of the disclosure will be described in detail with reference to FIGS. 3-17.

FIG. 3 is a perspective view illustrating a two-eye device 1 for a robot according to one or more embodiments of the disclosure.

Referring to FIG. 3, the two-eye device 1 for the robot according to one or more embodiments of the disclosure may include a left camera 2, a right camera 3, a motion generating device 7, a left-and-right tilting mechanism 4, an up-and-down tilting mechanism 5, and a focus adjusting mechanism 6.

The two-eye device 1 for the robot according to one or more embodiments of the disclosure may be disposed on a base 1a. The base 1a may be an internal part of a robot 100 on which the two-eye device 1 for the robot is disposed. The base 1a may be formed in various shapes as long as it can support the two-eye device 1 for the robot.

The left camera 2 and the right camera 3 may be disposed on the upper side of the base 1a.

The right camera 3 may be disposed to the right of the left camera 2 and may be spaced a certain distance apart from the left camera 2.

In some embodiments, the left camera 2 and the right camera 3 may be configured using cameras of the same, or different, specifications.

The motion generating device 7 may be configured to tilt the left camera 2 and the right camera 3 by a certain angle by selectively operating one of the left-and-right tilting mechanism 4, the up-and-down tilting mechanism 5, and the focus adjusting mechanism 6.

The motion generating device 7 may include a main shaft 10. The main shaft 10 of the motion generating device 7 may selectively perform one, or all, of a linear movement, a rotation, and a helical movement. For example, the motion generating device 7 may cause the main shaft 10 to move linearly. The motion generating device 7 may cause the main shaft 10 to rotate. The motion generating device 7 may cause the main shaft 10 to move helically.

The left-and-right tilting mechanism 4 may be connected to the motion generating device 7. When the main shaft 10 of the motion generating device 7 moves linearly in a direction parallel to the base 1a, the left camera 2 and the right camera 3 may be simultaneously tilted left and right by a certain angle by the left-and-right tilting mechanism 4.

For example, when the main shaft 10 of the motion generating device 7 moves linearly in one direction, the left camera 2 and the right camera 3 may simultaneously tilt to the left by a certain angle. Alternatively, when the main shaft 10 of the motion generating device 7 moves linearly in the opposite direction, the left camera 2 and the right camera 3 may simultaneously tilt to the right by a certain angle.

The up-and-down tilting mechanism 5 may be connected to the motion generating device 7. When the main shaft 10 of the motion generating device 7 performs a helical movement, the left camera 2 and the right camera 3 may be simultaneously tilted upward and downward by a certain angle relative to the base 1a by the up-and-down tilting mechanism 5.

For example, when the main shaft 10 of the motion generating device 7 performs a helical movement in one direction, the left camera 2 and the right camera 3 may simultaneously tilt upward by a certain angle. Alternatively, when the main shaft 10 of the motion generating device 7 moves in the opposite direction, the left camera 2 and the right camera 3 may simultaneously tilt downward by a certain angle.

The focus adjusting mechanism 6 may be connected to the motion generating device 7. When the main shaft 10 of the motion generating device 7 rotates, the left camera 2 and the right camera 3 may be tilted in opposite directions by the focus adjusting mechanism 6, so that the focal angle between the left camera 2 and the right camera 3 may be adjusted.

For example, when the main shaft 10 of the motion generating device 7 rotates in one direction, the focal angle between the left camera 2 and the right camera 3 may decrease. When the main shaft 10 of the motion generating device 7 rotates in the opposite direction, the focal angle between the left camera 2 and the right camera 3 may increase.

With reference to FIGS. 3-7, the motion generating device 7 of the two-eye device 1 for the robot according to one or more embodiments of the disclosure will be described in detail.

Referring to FIG. 3, the motion generating device 7 may include the main shaft 10, a linear bush 20, a screw bush 30, a first motor 8, and a second motor 9.

The main shaft 10 may be formed in a rod shape with a circular cross-section.

The main shaft 10 may include a helical groove 12 and a plurality of guide grooves 11.

The helical groove 12 may be formed on the outer circumferential surface of the main shaft 10. The helical groove 12 may be formed in a helical shape with a certain depth on the outer circumferential surface of the main shaft 10.

The plurality of guide grooves 11 may be formed on the outer circumferential surface of the main shaft 10 in the longitudinal direction of the main shaft 10. The plurality of guide grooves 11 may be formed at regular intervals in the circumferential direction of the main shaft 10. The guide grooves 11 may be linear grooves formed in the longitudinal direction of the main shaft 10. In other words, the guide grooves 11 may be formed with a certain depth along the entire length of the main shaft 10. The plurality of guide grooves 11 may intersect the helical groove 12.

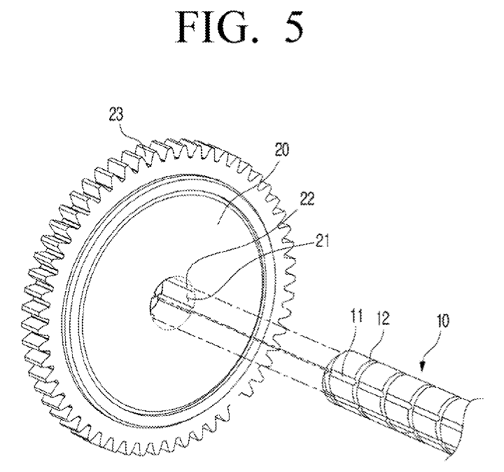

FIG. 4 is a side view illustrating a linear bush 20 coupled to a main shaft 10 of a two-eye device 1 for a robot according to one or more embodiments of the disclosure. FIG. 5 is a perspective view illustrating a main shaft 10 and a linear bush 20 of a two-eye device 1 for a robot according to one or more embodiments of the disclosure.

The linear bush 20 may be configured to rotate the main shaft 10. The linear bush 20 may be disposed so as to be slidable on the main shaft 10. For example, the linear bush 20 may be disposed so as to be slidably on a first end portion of the main shaft 10. The linear bush 20 may be disposed so as to be rotatable in place. Therefore, when the main shaft 10 moves, the linear bush 20 may not move left and right along the main shaft 10.

The linear bush 20 may include a hollow portion having a cylindrical shape. The hollow portion of the linear bush 20 may be formed to have a circular cross-section corresponding to the main shaft 10.

Referring to FIGS. 4 and 5, a plurality of guide protrusions 22 may be formed on the inner circumferential surface of the hollow portion of the linear bush 20. The plurality of guide protrusions 22 may be formed to correspond to the plurality of guide grooves 11 of the main shaft 10. For example, when the main shaft 10 includes four guide grooves 11, four guide protrusions 22 may be formed in the hollow portion of the linear bush 20.

Therefore, the plurality of guide protrusions 22 of the linear bush 20 may be inserted into the guide grooves 11 of the main shaft 10 to guide the linear movement of the main shaft 10. In other words, the plurality of guide protrusions 22 of the linear bush 20 may be formed to engage with the plurality of guide grooves 11 of the main shaft 10. Therefore, when the linear bush 20 rotates, the main shaft 10 may rotate by the plurality of guide protrusions 22 inserted into the plurality of guide grooves 11.

The linear bush 20 may include a first bush gear 23. The first bush gear 23 may be disposed concentrically with the linear bush 20 on the outer circumferential surface of the linear bush 20. The first bush gear 23 may be formed integrally with the linear bush 20. Therefore, when the first bush gear 23 rotates, the linear bush 20 may rotate integrally with the first bush gear 23.

The first motor 8 may be configured to generate a rotation force that rotates the linear bush 20. The first motor 8 may include a first motor shaft 8a. The first motor 8 may be disposed such that the first motor shaft 8a is parallel to the main shaft 10.

A first pinion 24 may be disposed on the first motor shaft 8a. The first pinion 24 may be disposed to mesh with the first bush gear 23. Therefore, when the first motor shaft 8a rotates, the first bush gear 23, which is meshed with the first pinion 24, may rotate. When the first bush gear 23 rotates, the linear bush 20 may rotate integrally with the first bush gear 23.

When the linear bush 20 rotates, the main shaft 10 may rotate by the plurality of guide protrusions 22 and the plurality of guide grooves 11 that are meshed with each other.

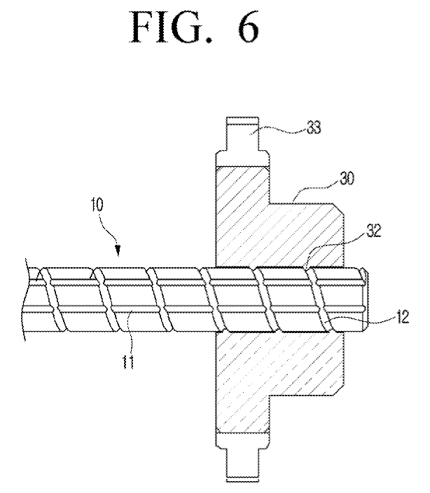

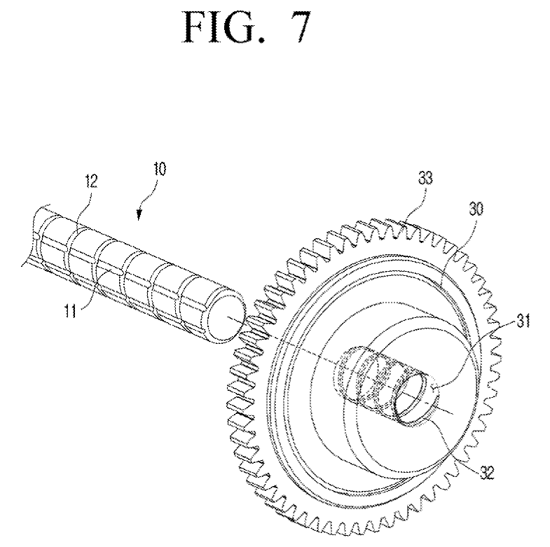

FIG. 6 is a cross-sectional view illustrating a screw bush 30 coupled to a main shaft 10 of a two-eye device 1 for a robot according to one or more embodiments of the disclosure. FIG. 7 is a perspective view illustrating a main shaft 10 and a screw bush 30 of a two-eye device 1 for a robot according to one or more embodiments of the disclosure.

The screw bush 30 may be configured to be screw-coupled with the main shaft 10. The screw bush 30 may be disposed so as to be helically movable on the main shaft 10. For example, the screw bush 30 may be disposed so as to be helically movable on a second end portion of the main shaft 10.

The screw bush 30 may be formed in a hollow cylindrical shape. A hollow 31 of the screw bush 30 may be formed so as to allow the main shaft 10 to be inserted therein. The hollow 31 of the screw bush 30 may be formed to have a circular cross-section corresponding to the main shaft 10.

Referring to FIGS. 6 and 7, a helical protrusion 32 may be formed on the inner circumferential surface of the hollow 31 of the screw bush 30. The helical protrusion 32 may be formed to correspond to the helical groove 12 of the main shaft 10. Accordingly, the screw bush 30 may be screwed to the main shaft 10.

The helical protrusion 32 of the screw bush 30 may be inserted into the helical groove 12 of the main shaft 10 to guide the helical movement of the main shaft 10. In other words, the helical protrusion 32 of the screw bush 30 may be formed to engage with the helical groove 12 of the main shaft 10. Therefore, when the screw bush 30 rotates, the main shaft 10 may be moved helically by the helical protrusion 32 inserted into the helical groove 12.

The screw bush 30 may include a second bush gear 33. The second bush gear 33 may be disposed concentrically with the screw bush 30 on the outer circumferential surface of the screw bush 30. The second bush gear 33 may be formed integrally with the screw bush 30. Therefore, when the second bush gear 33 rotates, the screw bush 30 may rotate integrally with the second bush gear 33. The screw bush 30 may be disposed on the main shaft 10 so that the screw bush 30 rotates in place. Therefore, when the main shaft 10 moves, the screw bush 30 may not move left and right along the main shaft 10.

The second motor 9 may be configured to generate rotation force to rotate the screw bush 30. The second motor 9 may include a second motor shaft 9a. The second motor 9 may be disposed such that the second motor shaft 9a is parallel to the main shaft 10.

A second pinion 34 may be disposed on the second motor shaft 9a. The second pinion 34 may be disposed to mesh with the second bush gear 33. Therefore, when the second motor shaft 9a rotates, the second bush gear 33, which is meshed with the second pinion 34, may rotate. When the second bush gear 33 rotates, the screw bush 30 may rotate integrally with the second bush gear 33.

When the screw bush 30 rotates, the main shaft 10 may move helically by the helical protrusion 32 and the helical groove 12 that are meshed with each other. In other words, when the screw bush 30 rotates in one direction, the main shaft 10 may move in a straight line in one direction while rotating in one direction.

Because the linear bush 20 is disposed at the first end portion of the main shaft 10 and the screw bush 30 is disposed at the second end portion thereof, one of linear movement, rotation, and helical movement of the main shaft 10 may be achieved by selectively rotating the linear bush 20 and the screw bush 30.

For example, when the first motor 8 operates so that the linear bush 20 rotates, and the second motor 9 does not operate so that the screw bush 30 does not rotate, the main shaft 10 may perform the helical movement by the screw bush 30. The helical movement direction of the main shaft 10 may change depending on the rotation direction of the first motor 8.

For example, when the first motor 8 does not operate so that the linear bush 20 does not rotate, and the second motor 9 operates so that the screw bush 30 rotates, the main shaft 10 may perform the linear movement by the linear bush 20. The linear movement direction of the main shaft 10 may change depending on the rotation direction of the second motor 9.

For example, when both the first motor 8 and the second motor 9 operate so that both the linear bush 20 and the screw bush 30 rotate, the main shaft 10 may rotate. At this time, the main shaft 10 may not move in the longitudinal direction.

The left-and-right tilting mechanism 4 of the two-eye device 1 for the robot according to one or more embodiments of the disclosure will be described in detail with reference to FIGS. 8-11.

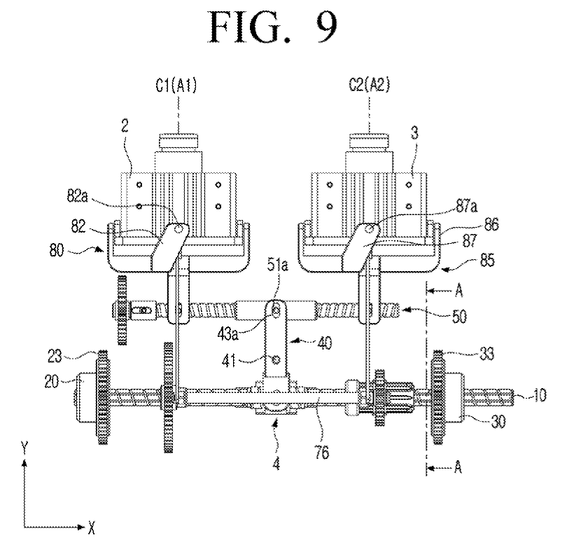

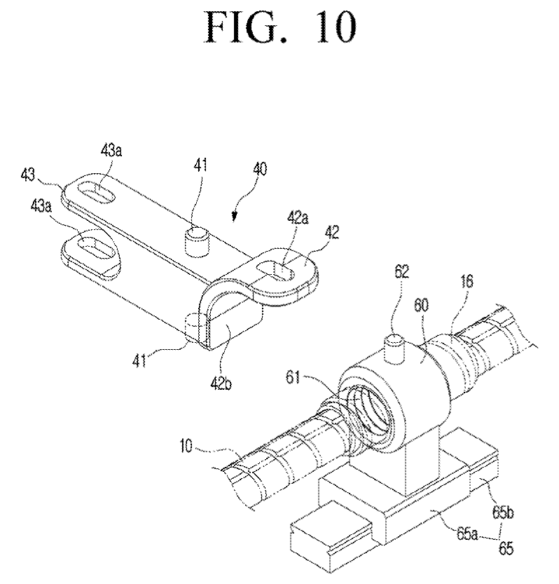

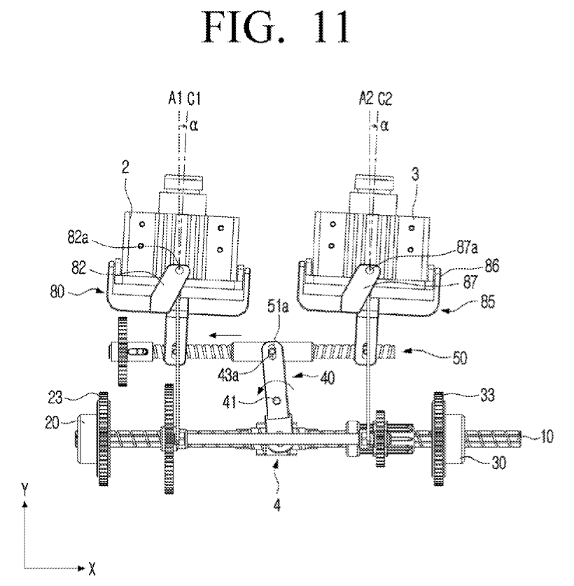

FIG. 8 is a perspective view illustrating a two-eye device 1 for a robot viewed in the Y-direction according to one or more embodiments of the disclosure. FIG. 9 is a plan view of the two-eye device 1 for the robot of FIG. 8 according to one or more embodiments of the disclosure. FIG. 10 is a perspective view illustrating a state in which a horizontal link 40 is separated from a main shaft 10 of a two-eye device 1 for a robot according to one or more embodiments of the disclosure. FIG. 11 is a view illustrating a state in which a left camera 2 and a right camera 3 of a two-eye device 1 for a robot are tilted to the right according to one or more embodiments of the disclosure.

The left-and-right tilting mechanism 4 may be connected to the main shaft 10 of the motion generating device 7. The left-and-right tilting mechanism 4 may be configured to convert the linear movement of the main shaft 10 into the left-and-right tilting of the left camera 2 and the right camera 3.

Referring to FIGS. 8 and 9, the left-and-right tilting mechanism 4 of the two-eye device 1 for the robot according to one or more embodiments of the disclosure may include a horizontal link 40 and a sub-shaft 50.

The horizontal link 40 may be disposed between the main shaft 10 and the sub-shaft 50. The horizontal link 40 may be configured to connect the main shaft 10 and the sub-shaft 50. The horizontal link 40 may be disposed so as to be rotatable on the upper surface of the base 1a.

Referring to FIGS. 8-10, the horizontal link 40 may include a link shaft 41. The link shaft 41 may be formed to protrude from the upper and lower surfaces of the horizontal link 40. The link shaft 41 may be disposed vertically on the base 1a. The link shaft 41 may be rotatably supported by a support component. Therefore, the horizontal link 40 may pivot about the link shaft 41.

The horizontal link 40 may include a first end 42 configured to receive the linear movement of the main shaft 10 and a second end 43 connected to a central portion 51 of the sub-shaft 50. The first end 42 and the second end 43 may be provided at both ends of the horizontal link 40. The link shaft 41 may be formed between the first end 42 and the second end 43.

The first end 42 of the horizontal link 40 may be connected so as to be able to pivot by a certain angle with respect to the main shaft 10. The second end 43 of the horizontal link 40 may be formed so as to be able to pivot with respect to the sub-shaft 50.

For example, a first connection hole 42a may be provided at the first end 42 of the horizontal link 40. A recess 42b formed to receive the main shaft 10 may be provided below the first end 42. The first connection hole 42a may be formed as an elongated hole. The main shaft 10 may include a first connection protrusion 62 that is inserted into the first connection hole 42a of the first end 42. When the first connection protrusion 62 of the main shaft 10 is inserted into the first connection hole 42a of the horizontal link 40, the main shaft 10 and the horizontal link 40 may be connected to each other. Therefore, when the main shaft 10 performs the linear movement, the horizontal link 40 may pivot by a certain angle about the link shaft 41.

For example, the main shaft 10 may include a lead screw 16. The lead screw 16 may be disposed at the central portion of the main shaft 10. The lead screw 16 may be formed to have a length shorter than the length of the main shaft 10. The diameter of the lead screw 16 may be larger than the diameter of the main shaft 10. A helical groove may be formed on the outer circumferential surface of the lead screw 16. The pitch of the helical groove of the lead screw 16 may be formed to be the same as the pitch of the helical groove 12 of the main shaft 10. Alternatively, the pitch of the helical groove of the lead screw 16 may be formed to be smaller than the pitch of the helical groove 12 of the main shaft 10.

The main shaft 10 may include a screw nut 60 configured to be screw-connected to the lead screw 16. The screw nut 60 may be connected to the first end 42 of the horizontal link 40. For example, the screw nut 60 may include a hollow portion, and a helical protrusion 61 may be formed on the inner circumferential surface of the hollow portion. The helical protrusion 61 of the screw nut 60 may be formed to correspond to the helical groove of the lead screw 16. Accordingly, the screw nut 60 may be screw-connected to the lead screw 16.

The screw nut 60 may be disposed on a linear movement guide member 65. The linear movement guide member 65 may be disposed below the screw nut 60 and may be configured to guide the linear movement of the screw nut 60. The linear movement guide member 65 may be disposed on the base 1a.

For example, the linear movement guide member 65 may be formed as a linear motion guide. The linear motion guide may include a rail 65b and a block 65a that is slidably disposed on the rail 65b. In other words, the block 65a is disposed on the rail 65b and is configured to slide along the rail 65b. The screw nut 60 may be disposed on the upper surface of the block 65a of the linear motion guide. Accordingly, the linear movement of the screw nut 60 may be guided by the linear motion guide.

However, the linear movement guide member 65 may not be limited to the linear motion guide. Various types of linear movement guide members 65 may be used as long as they can guide the linear movement of the screw nut 60.

For example, the second end 43 of the horizontal link 40 may include a U-shaped groove. The sub-shaft 50 may be accommodated in the U-shaped groove. A second connection hole 43a may be provided at the second end 43 of the horizontal link 40. Two second connection holes 43a may be provided at the upper and lower portions of the second end 43 of the horizontal link 40. The second connection holes 43a may be formed as elongated holes.

The sub-shaft 50 may include two second connection protrusions 51a provided in the central portion 51 thereof. The two second connection protrusions 51a may be inserted into the two second connection holes 43a of the second end 43 of the horizontal link 40. When the two second connection protrusions 51a of the sub-shaft 50 are inserted into the two second connection holes 43a of the second end 43 of the horizontal link 40, the sub-shaft 50 and the horizontal link 40 may be connected to each other. Therefore, when the horizontal link 40 is pivoted by the linear movement of the main shaft 10, the sub-shaft 50 may move linearly in the opposite direction.

The sub-shaft 50 may be disposed parallel to the main shaft 10. The sub-shaft 50 may be disposed so as to move parallel to the main shaft 10. The sub-shaft 50 may be disposed on the upper side of the base 1a and may move parallel to the base 1a. The sub-shaft 50 may be formed as a rod shape with a circular cross-section.

The sub-shaft 50 may be connected to the left camera 2 and the right camera 3. The left camera 2 may be connected to the left portion 52 of the sub-shaft 50, and the right camera 3 may be connected to the right portion 53 of the sub-shaft 50. The left camera 2 and the right camera 3 may be configured to tilt at a certain angle in the left and right direction according to the linear movement of the sub-shaft 50. For example, the left camera 2 may be connected to the left portion 52 of the sub-shaft 50 so as to tilt at a certain angle when the sub-shaft 50 moves linearly. The right camera 3 may be connected to the right portion 53 of the sub-shaft 50 so as to tilt at a certain angle when the sub-shaft 50 moves linearly.

The left camera 2 may be disposed to be able to tilt left and right by a certain angle about a first vertical axis V1 perpendicular to the base 1a. The right camera 3 may be disposed to be able to tilt left and right by a certain angle about a second vertical axis V2 perpendicular to the base 1a. The first vertical axis V1 and the second vertical axis V2 may be parallel to each other.

A left tilting bracket 80 may be disposed between the left camera 2 and the sub-shaft 50. A right tilting bracket 85 may be disposed on one side of the left tilting bracket 80 between the right camera 3 and the sub-shaft 50.

The left tilting bracket 80 may be configured so that the left camera 2 tilts left and right in accordance with the linear movement of the sub-shaft 50. The right tilting bracket 85 may be configured so that the right camera 3 tilts left and right in accordance with the linear movement of the sub-shaft 50. In other words, the left tilting bracket 80 and the right tilting bracket 85 may simultaneously tilt left and right in accordance with the linear movement of the sub-shaft 50.

For example, the left tilting bracket 80 may include a horizontal hinge 81, a vertical hinge 82, and a connecting portion 83.

The horizontal hinge 81 may be disposed behind the left camera 2 and may support the left camera 2 so that the left camera 2 tilts upward and downward. For example, the horizontal hinge 81 may be formed in a roughly U-shape with a flat bottom. A pair of hinges 81a may be provided on both arms of the horizontal hinge 81 to rotatably connect to both side surfaces of the left camera 2.

The horizontal hinge 81 may be disposed such that a horizontal axis H passing through the centers of the pair of hinges 81a of the horizontal hinge 81 is parallel to the sub-shaft 50. Therefore, the left camera 2 may tilt upward and downward about the horizontal axis H.

As illustrated in FIG. 3, when the left camera 2 includes a support plate 2a, the pair of hinges 81a of the horizontal hinge 81 may be rotatably connected to both side surfaces of the support plate 2a.

The vertical hinge 82 may be disposed approximately perpendicular to the horizontal hinge 81. The vertical hinge 82 may be formed integrally with the horizontal hinge 81 and may support the horizontal hinge 81 so that the horizontal hinge 81 tilts left and right. Accordingly, the left camera 2 disposed on the horizontal hinge 81 may tilt left and right at a certain angle about the vertical hinge 82.

For example, the vertical hinge 82 may be formed in a U-shape with a flat bottom. A pair of hinge shafts 82a protruding outwardly may be provided on both arms of the vertical hinge 82. The pair of hinge shafts 82a may be formed in a straight line. The vertical hinge 82 may rotate about the pair of hinge shafts 82a. The pair of hinge shafts 82a of the vertical hinge 82 may form the first vertical axis V1.

The hinge shaft 82a formed on the lower arm of the vertical hinge 82 may be rotatably supported by a support component provided on the base 1a. The hinge shaft 82a formed on the upper arm of the vertical hinge 82 may be rotatably supported by a support component provided on the upper side of the vertical hinge 82. Accordingly, the left camera 2 disposed on the horizontal hinge 81 may tilt left and right about the pair of hinge shafts 82a, i.e., the first vertical axis V1.

The connecting portion 83 may be formed to protrude from the horizontal hinge 81 toward the motion generating device 7. In other words, the connecting portion 83 may be formed to protrude from the horizontal hinge 81 in the opposite direction to the left camera 2.

A U-shaped groove may be formed at the leading end of the connecting portion 83. The U-shaped groove may be formed to accommodate a left nut 56 screwed onto the sub-shaft 50. A connecting hole 83a may be formed at the leading end of the connecting portion 83. Two connecting holes 83a may be formed at the upper and lower portions of the leading end of the connecting portion 83. The connecting holes 83a may be formed in elongated holes.

The left nut 56 may include two connecting protrusions 56a that are inserted into the two connecting holes 83a of the connecting portion 83. The two connecting protrusions 56a may be formed 180 degrees apart on the outer circumferential surface of the left nut 56. The left nut 56 may be formed to be screwed onto the left portion 52 of the sub-shaft 50.

When the two connecting protrusions 56a of the left nut 56 fastened to the sub-shaft 50 are inserted into the two connecting holes 83a of the connecting portion 83, the sub-shaft 50 and the connecting portion 83 of the left tilting bracket 80 may be connected to each other.

For example, the right tilting bracket 85 may include a horizontal hinge 86, a vertical hinge 87, and a connecting portion 88.

The horizontal hinge 86 may be disposed behind the right camera 3 and may support the right camera 3 so that the right camera 3 tilts upward and downward. For example, the horizontal hinge 86 may be formed in a roughly U-shape with a flat bottom. A pair of hinges 86a may be provided on both arms of the horizontal hinge 86 to rotatably connect to both side surfaces of the right camera 3.

The horizontal hinge 86 may be disposed such that a horizontal axis H passing through the centers of the pair of hinges 86a of the horizontal hinge 86 is parallel to the sub-shaft 50. Therefore, the right camera 3 may tilt upward and downward about the horizontal axis H. The horizontal axis H passing through the centers of the pair of hinges 86a of the horizontal hinge 86 of the right tilting bracket 85 may form a straight line with the horizontal axis H passing through the centers of the pair of hinges 81a of the horizontal hinge 81 of the left tilting bracket 80.

As illustrated in FIG. 3, when the right camera 3 includes a support plate 3a, the pair of hinges 86a of the horizontal hinge 86 of the right tilting bracket 85 may be rotatably connected to both side surfaces of the support plate 3a.

The vertical hinge 87 may be disposed approximately perpendicular to the horizontal hinge 86. The vertical hinge 87 may be formed integrally with the horizontal hinge 86 and may support the horizontal hinge 86 so that the horizontal hinge 86 tilts left and right. Accordingly, the right camera 3 disposed on the horizontal hinge 86 may tilt left and right at a certain angle about the vertical hinge 87.

For example, the vertical hinge 87 may be formed in a U-shape with a roughly flat bottom. A pair of hinge shafts 87a protruding outwardly may be provided on both arms of the vertical hinge 87. The pair of hinge shafts 87a may be formed in a straight line. The vertical hinge 87 may rotate about the pair of hinge shafts 87a. The pair of hinge shafts 87a of the vertical hinge 87 of the right tilting bracket 85 may form the second vertical axis V2.

The hinge shaft 87a formed on the lower arm of the vertical hinge 87 may be rotatably supported by the support component provided on the base 1a. The hinge shaft 87a formed on the upper arm of the vertical hinge 87 may be rotatably supported by the support component provided on the upper side of the vertical hinge 87. Accordingly, the right camera 3 disposed on the horizontal hinge 86 may tilt left and right about the pair of hinge shafts 87a, i.e., the second vertical axis V2.

The connecting portion 88 may be formed to protrude from the horizontal hinge 86 toward the motion generating device 7. In other words, the connecting portion 88 may be formed to protrude from the horizontal hinge 86 in a direction opposite to the right camera 3.

A U-shaped groove may be formed at the leading end of the connecting portion 88. The U-shaped groove may be formed to accommodate a right nut 57 screwed to the sub-shaft 50. A connecting hole 88a may be formed at the leading end of the connecting portion 88. Two connecting holes 88a may be formed at the upper and lower portions of the leading end of the connecting portion 88. The connecting holes 88a may be formed in elongated holes.

The right nut 57 may include two connecting protrusions 57a that are inserted into the two connecting holes 88a of the connecting portion 88. The two connecting protrusions 57a may be formed 180 degrees apart on the outer circumferential surface of the right nut 57. The right nut 57 may be formed to be screwed to the right portion 53 of the sub-shaft 50.

When the two connecting protrusions 57a of the right nut 57 fastened to the sub-shaft 50 are inserted into the two connecting holes 88a of the connecting portion 88, the sub-shaft 50 and the connecting portion 88 of the right tilting bracket 85 may be connected to each other.

Therefore, when the main shaft 10 moves linearly, the sub-shaft 50 may move linearly in the opposite direction by the horizontal link 40. When the sub-shaft 50 moves linearly, the left camera 2 connected to the left tilting bracket 80 and the right camera 3 connected to the right tilting bracket 85 may simultaneously tilt left and right.

Therefore, when the main shaft 10 of the motion generating device 7 performs linear movement, the sub-shaft 50 may move linearly by the horizontal link 40, so that the left camera 2 and the right camera 3 may be simultaneously tilted to the left or right by a certain angle.

For example, as illustrated in FIG. 11, when the main shaft 10 moves linearly to the right, the sub-shaft 50 may be moved linearly to the left by the horizontal link 40. When the sub-shaft 50 moves linearly to the left, the left tilting bracket 80 and the right tilting bracket 85 connected to both side portions of the sub-shaft 50 may simultaneously tilt to the right by a certain angle about the first vertical axis V1 and the second vertical axis V2, respectively. Because the left camera 2 is disposed in the left tilting bracket 80 and the right camera 3 is disposed in the right tilting bracket 85, when the left tilting bracket 80 and the right tilting bracket 85 are simultaneously tilted to the right by a certain angle, the left camera 2 and the right camera 3 may also be tilted to the right by a certain angle.

For example, the center line C1 of the left camera 2 may be tilted to the right at a certain angle α with respect to a vertical reference plane A1 of the left camera 2. At the same time, the center line C2 of the right camera 3 may also be tilted to the right at the same angle α with respect to a vertical reference plane A2 of the right camera 3.

Hereinafter, the up-and-down tilting mechanism 5 of the two-eye device 1 for the robot according to one or more embodiments of the disclosure will be described in detail with reference to FIGS. 3, 8, and 12-14.

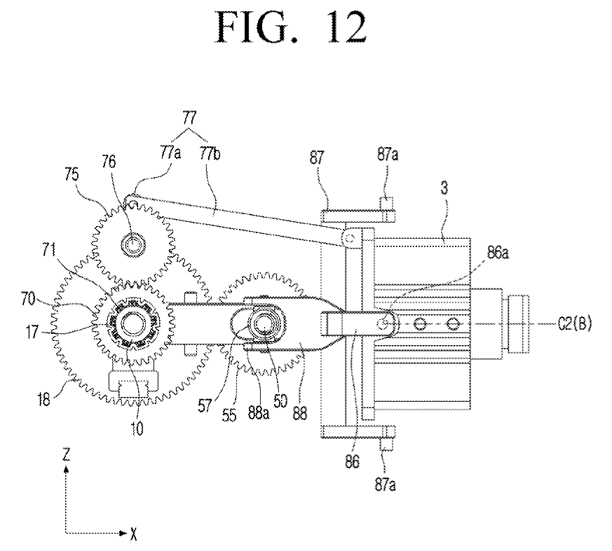

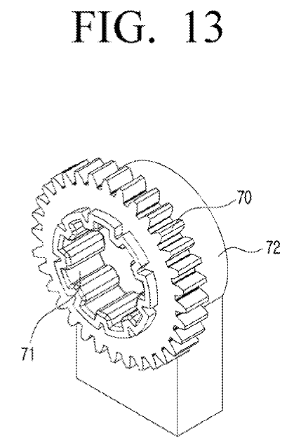

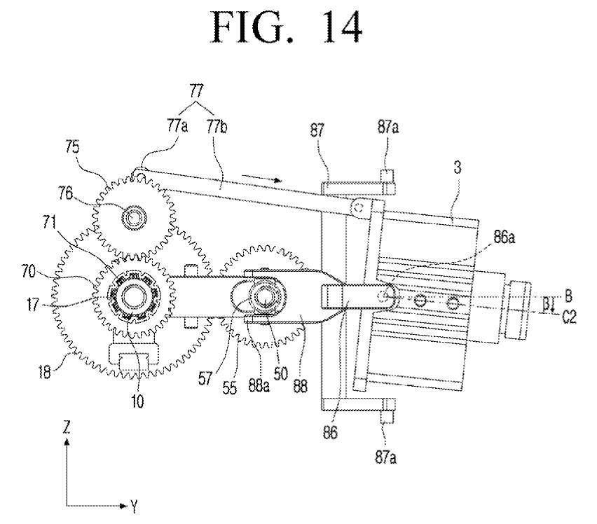

FIG. 12 is a cross-sectional view illustrating the two-eye device 1 for a robot taken along line A-A of FIG. 9 according to one or more embodiments of the disclosure. FIG. 13 is a perspective view illustrating a first tilting gear 70 of a two-eye device 1 for a robot according to one or more embodiments of the disclosure. FIG. 14 is a cross-sectional view illustrating a state in which a right camera 3 of the two-eye device 1 for a robot of FIG. 12 is tilted downward according to one or more embodiments of the disclosure.

The up-and-down tilting mechanism 5 may be connected to the main shaft 10 of the motion generating device 7. The up-and-down tilting mechanism 5 may be configured to convert the helical movement of the main shaft 10 into up-and-down tilting of the left camera 2 and the right camera 3.

Referring to FIGS. 3, 8, and 12, the up-and-down tilting mechanism 5 of the two-eye device 1 for the robot according to one or more embodiments of the disclosure may include a first tilting gear 70, a second tilting gear 75, a tilting shaft 76, and a pair of two-bar links 77 and 78.

The first tilting gear 70 may be disposed on the main shaft 10. The first tilting gear 70 may be configured to rotate when the main shaft 10 performs the helical movement.

For example, the main shaft 10 may include a spline 17. The spline 17 may be formed between the lead screw 16 and the screw bush 30. The spline 17 may be formed integrally with the main shaft 10. Therefore, the spline 17 may move integrally with the main shaft 10.

The first tilting gear 70 may include a spline boss 71 corresponding to the spline 17 of the main shaft 10. The spline boss 71 may be formed in the center of the first tilting gear 70. The spline boss 71 may be formed to correspond to the spline 17 of the main shaft 10. Accordingly, the spline 17 of the main shaft 10 may be detachably inserted into the spline boss 71.

As illustrated in FIG. 13, the first tilting gear 70 may be rotatably supported by a rotation support 72. A bearing supporting the rotation of the first tilting gear 70 may be disposed within the rotation support 72. The rotation support 72 that rotatably supports the first tilting gear 70 may be fixed to the base 1a. Accordingly, the first tilting gear 70 may maintain its original position without moving relative to the base 1a when the main shaft 10 moves.

When the main shaft 10 moves linearly, the spline 17 may slide through the spline boss 71 of the first tilting gear 70. Therefore, when the main shaft 10 moves linearly, the first tilting gear 70 may not move linearly.

When the main shaft 10 performs helical movement while the spline 17 is inserted into the spline boss 71 of the first tilting gear 70, the first tilting gear 70 may rotate by the spline 17 and the spline boss 71.

The second tilting gear 75 may mesh with the first tilting gear 70. The first tilting gear 70 and the second tilting gear 75 may form a tilting gear train.

The second tilting gear 75 may be disposed at one end of the tilting shaft 76. The tilting shaft 76 may be disposed at the center of the second tilting gear 75 parallel to the main shaft 10. The tilting shaft 76 may be rotatably supported by a support component disposed on the base 1a.

The pair of two-bar links 77 and 78 may be disposed at both ends of the tilting shaft 76. The pair of two-bar links 77 and 78 may include a left two-bar link 78 connected to the left camera 2 and a right two-bar link 77 connected to the right camera 3.

The right two-bar link 77 may be disposed adjacent to the second tilting gear 75. One end of the right two-bar link 77 may be connected to the tilting shaft 76, and the other end thereof may be connected to the right camera 3. For example, the right two-bar link 77 may include a first link 77a disposed on the tilting shaft 76 and a second link 77b connecting the first link 77a and the right camera 3. One end of the second link 77b may be rotatably connected to the first link 77a, and the other end thereof may be rotatably connected to the rear side of the right camera 3.

As illustrated in FIG. 3, when the right camera 3 includes the support plate 3a, the other end of the second link 77b may be pivotally connected to the rear surface of the support plate 3a.

Therefore, when the first link 77a of the right two-bar link 77 rotates by the tilting shaft 76, the right camera 3 may be tilted upward and downward by the second link 77b.

The right camera 3 may be disposed so as to tilt upward and downward at a certain angle about the horizontal axis H parallel to the tilting shaft 76. For example, when the right tilting bracket 85 is disposed between the sub-shaft 50 and the right camera 3, as described above, the right camera 3 may tilt upward and downward about the pair of hinges 86a of the horizontal hinge 86 of the right tilting bracket 85.

The left two-bar link 78 may be disposed a certain distance apart from the right two-bar link 77. One end of the left two-bar link 78 may be connected to the tilting shaft 76, and the other end thereof may be connected to the left camera 2. For example, the left two-bar link 78 may include a first link 78a disposed on the tilting shaft 76 and a second link 78b connecting the first link 78a and the left camera 2. One end of the second link 78b may be rotatably connected to the first link 78a, and the other end thereof may be rotatably connected to the rear side of the left camera 2. The left two-bar link 78 may be formed in the same manner as the right two-bar link 77.

As illustrated in FIG. 3, when the left camera 2 includes the support plate 2a, the other end of the second link 78b may be pivotally connected to the rear surface of the support plate 2a.

Therefore, when the first link 78a of the left two-bar link 78 rotates by the tilting shaft 76, the left camera 2 may be tilted upward and downward by the second link 78b.

The left camera 2 may be disposed so as to tilt upward and downward at a certain angle about the horizontal axis H parallel to the tilting shaft 76. For example, when the left tilting bracket 80 is disposed between the sub-shaft 50 and the left camera 2, as described above, the left camera 2 may tilt upward and downward about the pair of hinges 81a of the horizontal hinge 81 of the left tilting bracket 80.

Therefore, when the first tilting gear 70 rotates by the helical movement of the main shaft 10, the second tilting gear 75 may rotate. When the second tilting gear 75 rotates, the tilting shaft 76 may rotate, so that the first link 78a of the left two-bar link 78 and the first link 77a of the right two-bar link 77 may rotate integrally. Then, the left camera 2 connected to the second link 78b of the left two-bar link 78 and the right camera 3 connected to the second link 77b of the right two-bar link 77 may tilt upward and downward at a certain angle about the horizontal axis H.

For example, as illustrated in FIG. 14, when the first tilting gear 70 is rotated counterclockwise by a certain angle by the main shaft 10, the second tilting gear 75 may be rotated clockwise by a certain angle. When the second tilting gear 75 rotates clockwise by a certain angle, the right camera 3 may be tilted downward by a certain angle about the pair of hinges 86a by the right two-bar link 77.

In other words, when the second tilting gear 75 rotates clockwise by a certain angle, the first link 77a of the right two-bar link 77 rotates clockwise, and the second link 77b may be moved to the right (in the arrow direction) by the first link 77a, so that the right camera 3 may tilt downward by a certain angle about the hinges 86a. For example, the center line C2 of the right camera 3 may tilt downward by a certain angle β with respect to a horizontal reference plane B of the right camera 3.

At this time, the left camera 2 may also tilt downward by the same angle β about the pair of hinges 81a by the left two-bar link 78.

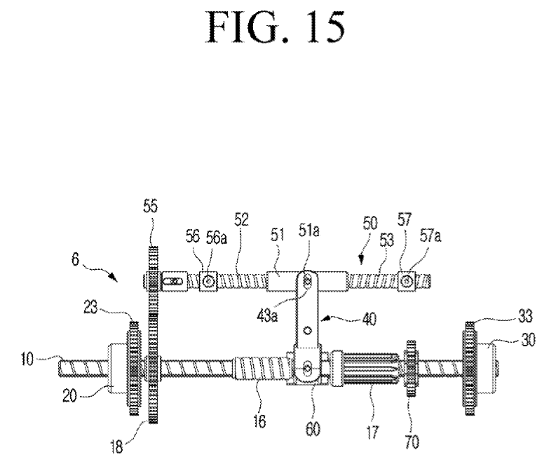

Hereinafter, with reference to FIGS. 15-17, the focus adjusting mechanism 6 of the two-eye device 1 for the robot according to one or more embodiments of the disclosure will be described in detail.

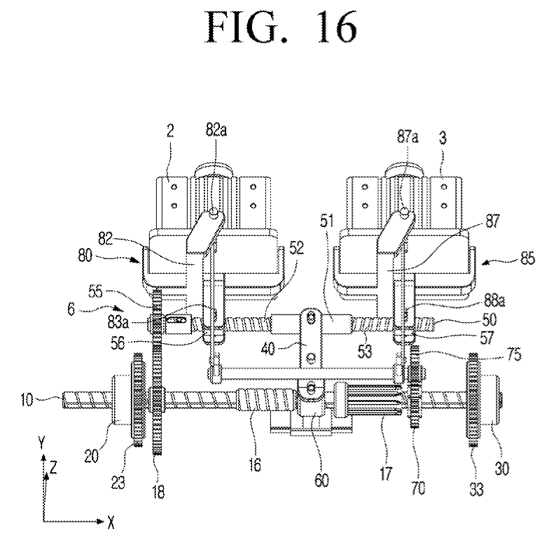

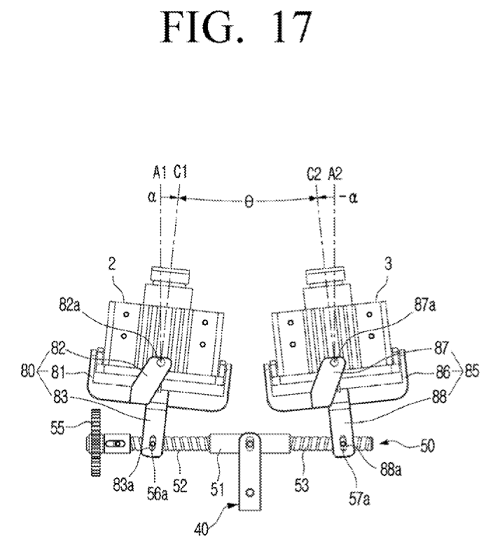

FIG. 15 is a perspective view illustrating a two-eye device 1 for a robot viewed in the Y direction according to one or more embodiments of the disclosure. FIG. 16 is a plan view illustrating the two-eye device 1 for a robot of FIG. 15 according to one or more embodiments of the disclosure. FIG. 17 is a partial plan view illustrating left and right cameras 2 and 3 of a two-eye device 1 for a robot in a focused state according to one or more embodiments of the disclosure.

The focus adjusting mechanism 6 may be connected to the main shaft 10 of the motion generating device 7. The focus adjusting mechanism 6 may be configured to adjust the focal angle between the left camera 2 and the right camera 3 using the rotation of the main shaft 10.

Referring to FIGS. 15 and 16, the focus adjusting mechanism 6 of the two-eye device 1 for the robot according to one or more embodiments of the disclosure may include a first focus gear 18, a second focus gear 55, a sub-shaft 50, a left nut 56, and a right nut 57.

The first focus gear 18 may be disposed on the main shaft 10. The first focus gear 18 may be disposed between the linear bush 20 and the lead screw 16. The first focus gear 18 may be disposed adjacent to the linear bush 20. The first focus gear 18 may be disposed to move integrally with the main shaft 10.

The second focus gear 55 may be disposed to selectively mesh with the first focus gear 18. For example, when the main shaft 10 moves linearly, the first focus gear 18 may engage or disengage with the second focus gear 55. When the first focus gear 18 engages with the second focus gear 55, the first focus gear 18 and the second focus gear 55 may form a focus gear train.

The second focus gear 55 may be disposed at one end of the sub-shaft 50. Therefore, when the second focus gear 55 rotates, the sub-shaft 50 may rotate integrally with the second focus gear 55.

The sub-shaft 50 may be disposed parallel to the main shaft 10. The sub-shaft 50 may be disposed between the left camera 2 and the main shaft 10. The sub-shaft 50 may be disposed on the upper side of the base 1a and may rotate integrally with the second focus gear 55. The sub-shaft 50 may be formed in a rod shape with a circular cross-section. In addition, the sub-shaft 50 may move left and right in parallel with the main shaft 10.

The sub-shaft 50 may include a central portion 51, a left portion 52, and a right portion 53. The left-hand thread portion and the right-hand thread portion may be formed both sides of the central portion 51 of the sub-shaft 50. For example, the left-hand thread portion may be formed on one side of the central portion 51, and the right-hand thread portion may be formed on the other side of the central portion 51. As an example, the left-hand thread portion may be formed on the left portion 52 of the sub-shaft 50, and the right-hand thread portion may be formed on the right portion 53. Alternatively, the left-hand thread portion may be formed on the right portion 53 of the sub-shaft 50, and the right-hand thread portion may be formed on the left portion 52 of the sub-shaft 50.

The central portion 51 may include two second connection protrusions 51a. The two second connection protrusions 51a may be formed to be inserted into the two second connection holes 43a of the second end 43 of the horizontal link 40.

The left nut 56 may be disposed on the left portion 52 of the sub-shaft 50. For example, when the left-hand thread portion is formed on the left portion 52 of the sub-shaft 50, the left nut 56 may be formed to correspond thereto.

The right nut 57 may be disposed on the right portion 53 of the sub-shaft 50. For example, when the right-hand thread portion is formed on the right portion 53 of the sub-shaft 50, the right nut 57 may be formed to correspond thereto.

Therefore, when the sub-shaft 50 rotates, the left nut 56 and the right nut 57 may move toward or away from the central portion 51. In other words, when the sub-shaft 50 rotates, the left nut 56 and the right nut 57 may move in opposite directions along the sub-shaft 50.

For example, when the sub-shaft 50 rotates in one direction, the left nut 56 and the right nut 57 fastened to the left portion 52 and the right portion 53 of the sub-shaft 50 may move along the sub-shaft 50 toward the central portion 51. When the sub-shaft 50 rotates in the opposite direction, the left nut 56 and the right nut 57 fastened to the sub-shaft 50 may move away from the central portion 51 along the sub-shaft 50.

The left nut 56 may be connected to the left camera 2, and the right nut 57 may be connected to the right camera 3.

The left camera 2 may be disposed to tilt left and right at a certain angle relative to the first vertical axis V1 perpendicular to the base 1a. For example, when the left tilting bracket 80 is disposed between the sub-shaft 50 and the left camera 2 as described above, the left camera 2 may tilt left and right about the pair of hinge shafts 82a of the vertical hinge 82 of the left tilting bracket 80.

The left nut 56 may include two connecting protrusions 56a that are able to be inserted into the two connecting holes 83a of the connecting portion 83 of the left tilting bracket 80. The two connecting protrusions 56a may be formed 180 degrees apart on the outer circumferential surface of the left nut 56.

When the two connecting protrusions 56a of the left nut 56, which are fastened to the left portion 52 of the sub-shaft 50, are inserted into the two connecting holes 83a of the connecting portion 83 of the left tilting bracket 80, the sub-shaft 50 and the connecting portion 83 of the left tilting bracket 80 may be connected to each other.

The right camera 3 may be disposed to tilt left and right at a certain angle relative to the second vertical axis V2 perpendicular to the base 1a. For example, when the right tilting bracket 85 is disposed between the sub-shaft 50 and the right camera 3 as described above, the right camera 3 may tilt left and right about the pair of hinge shafts 87a of the vertical hinge 87 of the right tilting bracket 85.

The right nut 57 may include two connecting protrusions 57a that are able to be inserted into the two connecting holes 88a of the connecting portion 88 of the right tilting bracket 85. The two connecting protrusions 57a may be formed 180 degrees apart on the outer circumferential surface of the right nut 57.

When the two connecting protrusions 57a of the right nut 57, which are fastened to the right portion 53 of the sub-shaft 50, are inserted into the two connecting holes 88a of the connecting portion 88 of the right tilting bracket 85, the sub-shaft 50 and the connecting portion 88 of the right tilting bracket 85 may be connected to each other.

Accordingly, when the sub-shaft 50 rotates in one direction so that the left nut 56 and the right nut 57 move along the sub-shaft 50 toward the central portion 51, the focal angle between the left camera 2 and the right camera 3 may decrease. When the sub-shaft 50 rotates in the opposite direction so that the left nut 56 and the right nut 57 move along the sub-shaft 50 away from the central portion 51, the focal angle between the left camera 2 and the right camera 3 may increase.

For example, as illustrated in FIG. 17, when the left nut 56 and the right nut 57 move away from each other along the sub-shaft 50 due to the rotation of the second focus gear 55, the focal angle θ between the left camera 2 and the right camera 3 may increase. Here, the focal angle θ between the left camera 2 and the right camera 3 refers to the angle between the center line C1 of the left camera 2 and the center line C2 of the right camera 3.

As the focal angle θ increases, the focal distance of the two-eye device 1 for the robot may decrease. As the focal angle θ decreases, the focal distance of the two-eye device 1 for the robot may increase. Here, the focal distance refers to the distance from the image sensor surfaces of the left camera 2 and the right camera 3 to the point where the center line C1 of the left camera 2 and the center line C2 of the right camera 3 intersect.

Hereinafter, with reference to FIGS. 3, 8, 9, 11, 12, 14, 15, and 17, the operation of the two-eye device 1 for the robot according to one or more embodiments of the disclosure will be described in detail.

As illustrated in FIGS. 3, 8, and 9, the left camera 2 and the right camera 3 of the two-eye device 1 for the robot according to one or more embodiments of the disclosure may face the front. In other words, the center line C1 of the left camera 2 and the center line C2 of the right camera 3 may be oriented in a direction parallel to the Y-axis direction. The center line C1 of the left camera 2 may be located on a vertical reference plane A1 of the left camera 2, and the center line C2 of the right camera 3 may be located on a vertical reference plane A2 of the right camera 3. Here, the vertical reference plane A1 of the left camera 2 refers to a plane that passes through the center line of the pair of hinge shafts 82a of the vertical hinge 82 of the left tilting bracket 80 and is parallel to the Y-axis, and the vertical reference plane A2 of the right camera 3 refers to a plane that passes through the center line of the pair of hinge shafts 87a of the vertical hinge 87 of the right tilting bracket 85 and is parallel to the Y-axis.

At this time, the lead screw 16 of the main shaft 10 may be coupled to the screw nut 60, and the spline 17 of the main shaft 10 may be coupled to the spline boss 71 of the first tilting gear 70.

In the state illustrated in FIG. 9, when the second motor 9 operates, the screw bush 30 may rotate by the second pinion 34 and the second bush gear 33. At this time, the first motor 8 may not operate. When the screw bush 30 rotates, the main shaft 10 may move linearly.

When the main shaft 10 moves linearly, the screw nut 60 coupled to the lead screw 16 of the main shaft 10 may move along the linear movement guide member 65. When the screw nut 60 moves, the horizontal link 40 connected to the screw nut 60 may pivot at a certain angle about the link shaft 41. When the horizontal link 40 pivots at a certain angle, the sub-shaft 50 connected to the other end of the horizontal link 40 may move in a straight line in the opposite direction to the main shaft 10.

When the sub-shaft 50 moves linearly, the left camera 2 and the right camera 3 connected to the sub-shaft 50 may tilt left and right by a certain angle. At this time, the left camera 2 and the right camera 3 may be tilted simultaneously by a certain angle in the same direction. For example, as illustrated in FIG. 11, the sub-shaft 50 moves linearly to the left, the left camera 2 connected to the left portion 52 of the sub-shaft 50 may be tilted to the right by a certain angle about the pair of hinge shafts 82a of the left tilting bracket 80, and the right camera 3 connected to the right portion 53 of the sub-shaft 50 may be tilted to the right by a certain angle about the pair of hinge shafts 87a of the right tilting bracket 85.

In the state illustrated in FIG. 9, when the first motor 8 operates, the linear bush 20 may rotate by the first pinion 24 and the first bush gear 23. At this time, the second motor 9 may not operate. When the linear bush 20 rotates, the main shaft 10 may perform helical movement.

When the main shaft 10 performs the helical movement, the first tilting gear 70 coupled to the spline 17 of the main shaft 10 may rotate. At this time, because the screw nut 60 is screw-connected to the lead screw 16 of the main shaft 10, the screw nut 60 may remain stationary without moving along with the main shaft 10 when the main shaft 10 performs the helical movement.

When the first tilting gear 70 rotates, the second tilting gear 75 may rotate. When the second tilting gear 75 rotates, the tilting shaft 76 may rotate integrally with the second tilting gear 75. When the tilting shaft 76 rotates, the leading end of the left two-bar link 78 and the leading end of the right two-bar link 77 may move in the Y-axis direction.

When the leading end of the left two-bar link 78 and the leading end of the right two-bar link 77 move in the Y-axis direction, the left camera 2 connected to the left two-bar link 78 and the right camera 3 connected to the right two-bar link 77 may be tilted upward and downward at a certain angle. At this time, the left camera 2 and the right camera 3 may be tilted simultaneously by a certain angle in the same direction.

For example, as illustrated in FIG. 14, when the second tilting gear 75 rotates clockwise due to the helical movement of the main shaft 10, the right two-bar link 77 may move in the arrow direction to push the right camera 3 in the Y-axis direction. Then, the right camera 3 may be tilted downward at a certain angle β about the pair of hinges 86a of the horizontal hinge 86 of the right tilting bracket 85. At this time, because the left two-bar link 78 is connected to the tilting shaft 76 on which the second tilting gear 75 is disposed, the left camera 2 may also be tilted downward at a certain angle about the pair of hinges 81a of the horizontal hinge 81 of the left tilting bracket 80 in the same manner as the right camera 3.

When adjusting the focal angle θ between the left camera 2 and the right camera 3, the first focus gear 18 disposed on the main shaft 10 may be moved to engage with the second focus gear 55 disposed on the sub-shaft 50.

For example, in the state of FIG. 9, when the second motor 9 is operated to move the main shaft 10 to the left, the first focus gear 18 of the main shaft 10 may mesh with the second focus gear 55 of the sub-shaft 50, as illustrated in FIG. 15. When only one of the first motor 8 and the second motor 9 is operated, the other motor that is not operated may be controlled so that the motor shaft thereof does not rotate and remains stationary.

As illustrated in FIG. 15, when the first focus gear 18 and the second focus gear 55 are engaged with each other and the main shaft 10 is rotated, the second focus gear 55 may rotate. When the first motor 8 and the second motor 9 are operated simultaneously, the main shaft 10 may rotate without moving left and right.

When the second focus gear 55 rotates, the sub-shaft 50 may rotate integrally with the second focus gear 55. When the sub-shaft 50 rotates, the left nut 56 disposed on the left portion 52 of the sub-shaft 50 and the right nut 57 disposed on the right pinion 54 of the sub-shaft 50 may move linearly in opposite directions along the sub-shaft 50.

When the left nut 56 and the right nut 57 move linearly along the sub-shaft 50, the left camera 2 and connected to the left nut 56 and the right camera 3 connected to the right nut 57 may tilt the opposite directions, thereby adjusting the focal angle θ between the left camera 2 and the right camera 3.

For example, as illustrated in FIG. 17, when the second focus gear 55 rotates in one direction so that the left nut 56 and the right nut 57 move away from each other along the sub-shaft 50, the focal angle θ between the left camera 2 and the right camera 3 may increase. When the second focus gear 55 rotates in the opposite direction so that the left nut 56 and the right nut 57 move closer to each other along the sub-shaft 50, the focal angle θ between the left camera 2 and the right camera 3 may decrease.

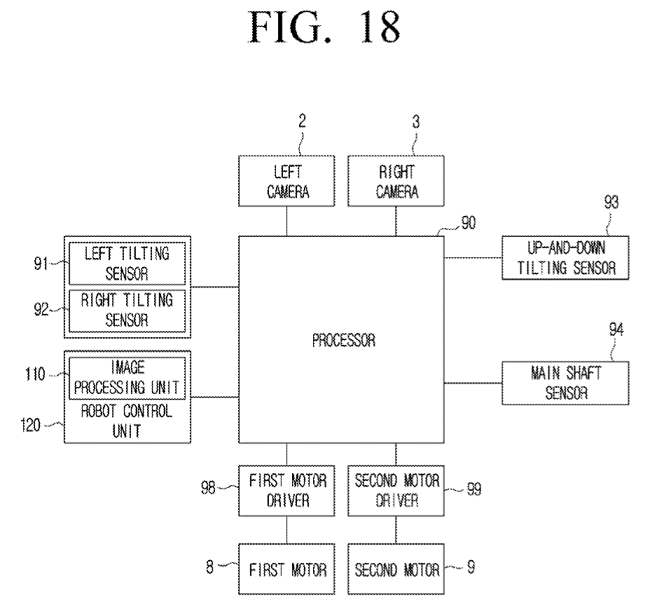

FIG. 18 is a functional block diagram illustrating a two-eye device 1 for a robot according to one or more embodiments of the disclosure.

Referring to FIG. 18, a two-eye device 1 for the robot according to one or more embodiments of the disclosure may include a left camera 2, a right camera 3, a left tilting sensor 91, a right tilting sensor 92, an up-and-down tilting sensor 93, a main shaft sensor 94, a first motor 8, a second motor 9, and one or more processors 90. In some embodiments, the two-eye device 1 may only include the two motors 8 and 9.

The left camera 2 and the right camera 3 may be configured to capture an object and form an image of the object. In other words, the left camera 2 and the right camera 3 may be configured as image sensors capable of capturing an object and forming an image of the object.

The left tilting sensor 91 may be configured to detect an angle at which the left camera 2 is tilted to the left or right. The right tilting sensor 92 may be configured to detect an angle at which the right camera 3 is tilted to the left or right. The left tilting sensor 91 may be configured as a physical sensor or software capable of measuring the angle at which the left camera 2 is tilted to the left or right. The right tilting sensor 92 may be configured as a physical sensor or software capable of measuring the angle at which the right camera 3 is tilted to the left or right.

The up-and-down tilting sensor 93 may be configured to detect an angle at which the left camera 2 or the right camera 3 is tilted upward or downward. The up-and-down tilting sensor 93 may be configured as a physical sensor or software capable of measuring the angle at which the left camera 2 or the right camera 3 is tilted upward or downward.

The main shaft sensor 94 may be configured to measure the linear movement distance of the main shaft 10, the helical movement amount of the main shaft 10, and the rotational angle of the main shaft 10. The main shaft sensor 94 may be configured as a physical sensor or software capable of measuring the linear movement distance of the main shaft 10, the helical movement amount of the main shaft 10, and the rotational angle of the main shaft 10.

The first motor 8 and the second motor 9 may be configured to generate rotation force. The first motor 8 may be configured to generate a rotation force for rotating the linear bush 20. The second motor 9 may be configured to generate a rotation force for rotating the screw bush 30. The first motor 8 and the second motor 9 may be configured as servo motors or stepping motors.

The first motor 8 may be controlled by a first motor driver 98. The second motor 9 may be controlled by a second motor driver 99.

The one or more processors 90 may be configured to control the two-eye device 1 for the robot according to one or more embodiments of the disclosure. The one or more processors 90 may control the left camera 2 and the right camera 3 to capture an image of an object.

The one or more processors 90 may control the first motor driver 98 and the second motor driver 99 to control the first motor 8 and the second motor 9. The one or more processors 90 may control the first motor 8 and the second motor 9 to tilt the left camera 2 and the right camera 3 to the left or right by a certain angle. The one or more processors 90 may control the first motor 8 and the second motor 9 to tilt the left camera 2 and the right camera 3 upward or downward at a certain angle. The one or more processors 90 may control the first motor 8 and the second motor 9 to adjust the focal angle between the left camera 2 and the right camera 3.

The one or more processors 90 may be electrically connected to an image processing unit 110. The image processing unit 110 may be configured separately from the two-eye device 1 for the robot according to one or more embodiments of the disclosure. For example, the image processing unit 110 may be provided in a robot control unit 120 configured to control the robot 100. The robot control unit 120 may control the image processing unit 110 to perform image processing on images captured by the left camera 2 and the right camera 3 and recognize the object using the image-processed data.

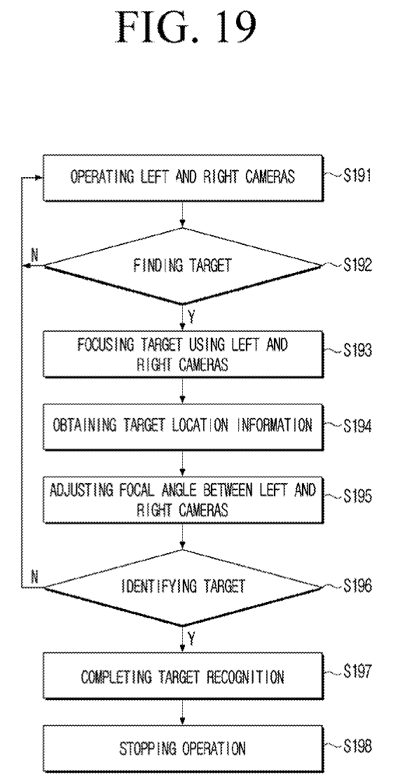

Hereinafter, an operation of a two-eye device 1 for the robot for recognizing an object according to one or more embodiments of the disclosure will be described with reference to FIG. 19.

FIG. 19 is a flowchart illustrating operation of a two-eye device 1 for a robot according to one or more embodiments of the disclosure.

The robot 100 may recognize an object to be searched for (hereinafter, referred to as a target) using the two-eye device 1 for the robot.

First, the one or more processors 90 may operate the left camera 2 and the right camera 3 of the two-eye device 1 for the robot according to one or more embodiments of the disclosure (S191). In other words, the one or more processors 90 may control the motion generating device 7 to tilt the left camera 2 and the right camera 3 left and right or upward and downward to find a target.

The robot control unit 120 may use the image processing unit 110 to process the images captured by the left camera 2 and the right camera 3 to find the target (S192).

When the robot control unit 120 fails to find the target (S192-N), the one or more processors 90 may control the motion generating device 7 to continue tilting the left camera 2 and the right camera 3 left and right or upward and downward to find the target.

When the robot control unit 120 detects the target (S192-Y), the one or more processors 90 may control the left camera 2 and the right camera 3 to focus on the target (S193). Then, the robot control unit 120 may obtain target location information using a distance sensor (S194).

When the robot control unit 120 obtains the target location information, the one or more processors 90 may adjust the focal angle between the left camera 2 and the right camera 3 (S195). For example, when the focal angle between the left camera 2 and the right camera 3 is not appropriate, the target may appear as two separate objects. When the focal angle between the left camera 2 and the right camera 3 is appropriate, the target may be clearly seen.

At this time, the robot control unit 120 may use the image processing unit 110 to process the images captured by the left camera 2 and the right camera 3 to identify the target (S196). In other words, the robot control unit 120 may identify whether the image processed by the image processing unit 110 matches the target.

When the image of the object captured by the left camera 2 and the right camera 3 recognized by the robot control unit 120 does not match the target (S196-N), the one or more processors 90 may control the motion generating device 7 to continuously tilt the left camera 2 and the right camera 3 left and right or upward and downward to find the target.

When the image of the object captured by the left camera 2 and the right camera 3 recognized by the robot control unit 120 matches the target (S196-Y), the robot control unit 120 may identify that target recognition is complete (S197) and may stop the operation of the two-eye device 1 for the robot (S198).

The two-eye device 1 for the robot according to one or more embodiments of the disclosure having the above-described structure may perform up-and-down tilting, left-and-right tilting, and focus adjustment of the left camera 2 and the right camera 3 using two motors. Therefore, the two-eye device 1 for the robot according to one or more embodiments of the disclosure may reduce the number of motors used compared to the two-eye device for the robot according to the prior art, thereby reducing the manufacturing cost and installation space of the two-eye device 1 for the robot.

In the foregoing, the disclosure has been shown and described with reference to various embodiments. However, it is understood by those skilled in the art that various changes may be made in form and detail without departing from the scope of the disclosure as defined by the appended claims and equivalents thereof.

What is claimed is:

1. A two-eye device for a robot comprising:
a base;
a left camera on an upper side of the base;
a right camera on the upper side of the base, wherein the right camera is to the right of the left camera;
a motion generating device comprising a main shaft, wherein the motion generating device is configured to cause the main shaft to perform a linear movement, a rotation, and a helical movement;
a left-and-right tilting mechanism connected to the motion generating device and configured to simultaneously tilt the left camera and the right camera by an angle in a left or a right direction based on the main shaft performing the linear movement in a direction parallel to the base;
an up-and-down tilting mechanism connected to the motion generating device and configured to simultaneously tilt the left camera and the right camera upward or downward by an angle relative to the base based on the main shaft performing the helical movement;
a focus adjusting mechanism connected to the motion generating device and configured to adjust a focal angle between the left camera and the right camera based on the main shaft performing the rotation; and
a first motor and a second motor configured to operate the motion generating device.

2. The two-eye device for the robot of claim 1, wherein
the motion generating device comprises:
a linear bush on a first end portion of the main shaft and configured to rotate the main shaft;
a screw bush connected to a second end portion of the main shaft and configured to helically move the main shaft;
a first bush gear on an outer circumferential surface of the linear bush and configured to rotate by the first motor; and
a second bush gear on an outer circumferential surface of the screw bush and configured to rotate by the second motor.

3. The two-eye device for the robot of claim 2, wherein
the main shaft comprises:
a helical groove on an outer circumferential surface of the main shaft; and
a plurality of guide grooves at regular intervals in a circumferential direction on the outer circumferential surface of the main shaft and in a straight line corresponding to a length of the main shaft.

4. The two-eye device for the robot of claim 3, wherein
the linear bush comprises:
a hollow portion, wherein the main shaft is in the hollow portion; and
a plurality of guide protrusions on an inner circumferential surface of the hollow portion and configured to engage with the plurality of guide grooves of the main shaft.

5. The two-eye device for the robot of claim 3, wherein
the screw bush comprises:
a hollow portion, wherein the main shaft is in the hollow portion; and
a helical protrusion on an inner circumferential surface of the hollow portion and configured to engage with the helical groove of the main shaft.

6. The two-eye device for the robot of claim 1, wherein
the left-and-right tilting mechanism comprises:
a sub-shaft configured to move parallel to the main shaft, and to which the left camera and the right camera are connected; and
a horizontal link configured to rotate about a link axis perpendicular to the base and comprising a first end to receive the linear movement of the main shaft and a second end connected to a central portion of the sub-shaft,
wherein based on the main shaft of the motion generating device performing the linear movement, the sub-shaft is configured to move linearly by the horizontal link, so that the left camera and the right camera are simultaneously tilted to the left or right by an angle.

7. The two-eye device for the robot of claim 6, wherein
the left-and-right tilting mechanism further comprises:
a lead screw at a central portion of the main shaft;
a screw nut coupled to the lead screw and connected to the first end of the horizontal link; and
a linear movement guide member below the screw nut and configured to guide a linear movement of the screw nut.

8. The two-eye device for the robot of claim 1, wherein
the focus adjusting mechanism comprises:
a first focus gear on the main shaft;
a sub-shaft parallel to the main shaft and comprising a central portion, a left-hand thread portion on one side of the central portion, and a right-hand thread portion on another side of the central portion;
a second focus gear at one end of the sub-shaft and configured to mesh with the first focus gear;
a left nut on the left-hand thread portion of the sub-shaft and connected to the left camera; and
a right nut on the right-hand thread portion of the sub-shaft and connected to the right camera.

9. The two-eye device for the robot of claim 8, wherein
the left camera is configured to pivot left and right at an angle about a first vertical axis perpendicular to the base, and
the right camera is configured to pivot left and right at an angle about a second vertical axis perpendicular to the base.

10. The two-eye device for the robot of claim 1, wherein
the up-and-down tilting mechanism comprises:
a first tilting gear on the main shaft;
a second tilting gear meshed with the first tilting gear;
a tilting shaft parallel to the main shaft and at a center of the second tilting gear;
a right two-bar link adjacent to the second tilting gear and having a first end connected to the tilting shaft and a second end connected to the right camera; and
a left two-bar link spaced apart from the right two-bar link by an angle and having a first end connected to the tilting shaft and a second end connected to the left camera.

11. The two-eye device for the robot of claim 10, wherein
the left camera is configured to pivot upward and downward at an angle about a horizontal axis parallel to the tilting shaft, and
the right camera is configured to pivot upward and downward at an angle about the horizontal axis.

12. The two-eye device for the robot of claim 10, wherein
the main shaft comprises a spline,
the first tilting gear comprises a spline boss, the spline is in the spline boss, and
the first tilting gear is rotatably supported by a rotation support on the base.

13. The two-eye device for the robot of claim 1, wherein
the left camera comprises a left tilting bracket configured to support the left camera so that the left camera is able to tilt left and right and upward and downward, and
the right camera comprises a right tilting bracket configured to support the right camera so that the right camera is able to tilt left and right and upward and downward.

14. The two-eye device for the robot of claim 13, wherein
the left tilting bracket comprises:
a horizontal hinge behind the left camera and configured to support the left camera to tilt upward and downward;
a vertical hinge perpendicular to and integrally with the horizontal hinge and configured to support the horizontal hinge to tilt left and right; and
a connecting portion to protrude from the horizontal hinge toward the motion generating device, and
the right tilting bracket comprises:
a horizontal hinge behind the right camera and configured to support the right camera to tilt upward and downward;
a vertical hinge perpendicular to and integrally with the horizontal hinge and configured to support the horizontal hinge to tilt left and right; and
a connecting portion to protrude from the horizontal hinge toward the motion generating device.

15. The two-eye device for the robot of claim 14, wherein
based on the left-and-right tilting mechanism operating, the left camera is configured to tilt left and right about the vertical hinge of the left tilting bracket, and the right camera is configured to tilt left and right about the vertical hinge of the right tilting bracket, and
based on the up-and-down tilting mechanism operating, the left camera is configured to tilt upward and downward about the horizontal hinge of the left tilting bracket, and the right camera is configured to tilt upward and downward about the horizontal hinge of the right tilting bracket.
